(19) United States
(12) Patent Application Publication
(10) Pub. No.: US 2024/0386294 A1
(43) Pub. Date: Nov. 21, 2024

(54) RESOURCE FORECASTING USING ARTIFICIAL INTELLIGENCE TECHNIQUES

(71) Applicant: Dell Products L.P., Round Rock, TX (US)

(72) Inventors: Abhishek Sharma, Berlin (DE); Anat Parush Tzur, Beer Sheva (IL); Prateek Srivastava, Cedar Park, TX (US); Rahul Namdev, Bhopal (IN); Amihai Savir, Newton, MA (US); Parag Suryakant Ved, Round Rock, TX (US); Carlos Jose De Olaguibel, Round Rock, TX (US); Anvesh Kalia, Round Rock, TX (US); Katarina Kovacova, Slovakia (SK); Shailesh Dhekne, Pune (IN); Ryan P. Weninger, Austin, TX (US); Anne E. Guinard, Austin, TX (US)

(21) Appl. No.: 18/197,347

(22) Filed: May 15, 2023

(51) Int. Cl. G06N 5/04

(52) U.S. Cl. CPC G06N 5/04

(57) ABSTRACT

Methods, apparatus, and processor-readable storage media for resource forecasting using artificial intelligence techniques are provided herein. An example computer-implemented method includes generating at least one resource-related forecast by processing, using a first set of artificial intelligence techniques, resource-related data and user-related data associated with prior activity related to the resource within a predetermined temporal period; modifying the at least one resource-related forecast using one or more temporal window regressors; predicting data associated with future activity related to the resource within the predetermined temporal period using a second set of artificial intelligence techniques; generating at least one combined resource-related forecast, for at least a portion of the predetermined temporal period, based on at least a portion of the at least one modified resource related forecast and at least a portion of the predicted data; and performing automated actions based on the at least one combined resource-related forecast.

### FIELD

The field relates generally to information processing systems, and more particularly to resource management in such systems.

### BACKGROUND

Resource forecasting can theoretically facilitate resource-related planning and reduce resource-related risks. However, conventional resource forecasting techniques typically rely on assumption-based labor-intensive processes which predominantly use historical data, and such techniques often result in inaccuracies and/or errors.

### SUMMARY

Illustrative embodiments of the disclosure provide techniques for resource forecasting using artificial intelligence techniques.

An exemplary computer-implemented method includes generating at least one resource-related forecast by processing, using at least a first set of one or more artificial intelligence techniques, resource-related data and user-related data associated with prior activity related to the resource within at least one predetermined temporal period. The method also includes modifying the at least one resource-related forecast using one or more temporal window regressors and predicting data associated with future activity related to the resource within the at least one predetermined temporal period using at least a second set of one or more artificial intelligence techniques. Additionally, the method includes generating at least one combined resource-related forecast, for at least a portion of the at least one predetermined temporal period, based at least in part on at least a portion of the at least one modified resource related forecast and at least a portion of the predicted data. Further, the method also includes performing one or more automated actions based at least in part on the at least one combined resource-related forecast.

Illustrative embodiments can provide significant advantages relative to conventional resource forecasting techniques. For example, problems associated with inaccuracies and/or errors are overcome in one or more embodiments through automatically generating resource forecasts using artificial intelligence techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for resource forecasting using artificial intelligence techniques in an illustrative embodiment.

FIG. 2 shows example system architecture in an illustrative embodiment.

FIG. 3 is a flow diagram of a process for resource forecasting using artificial intelligence techniques in an illustrative embodiment.

FIGS. 4 and 5 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

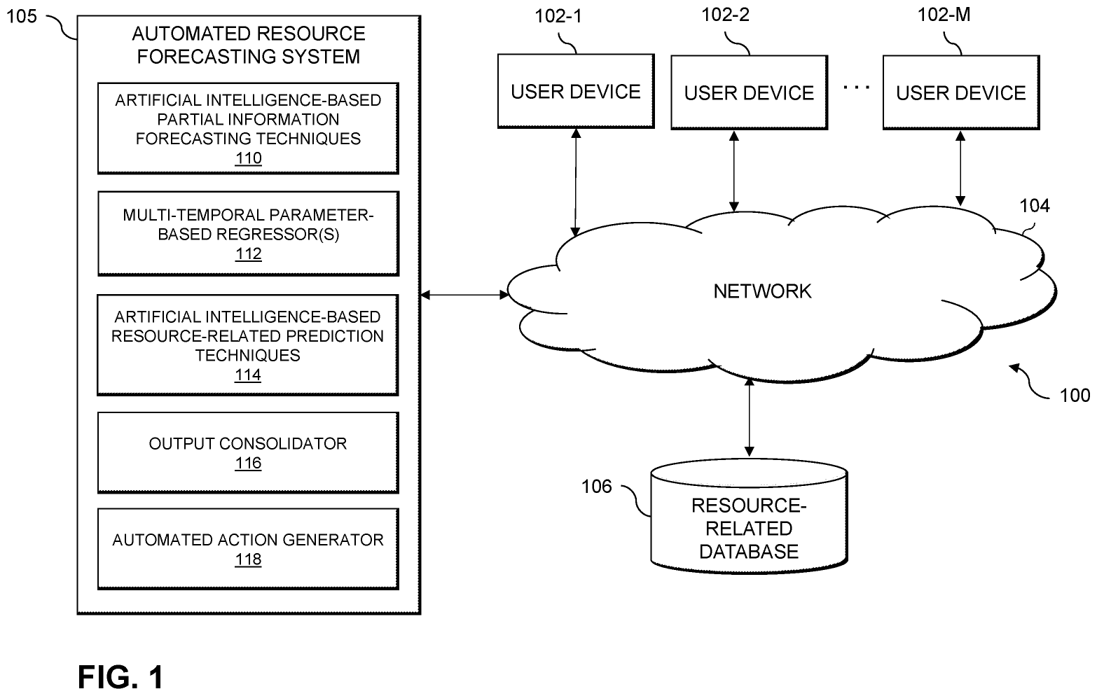

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated resource forecasting system 105.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, automated resource forecasting system 105 can have an associated resource-related database 106 configured to store data pertaining to users of given resources, enterprises associated with given resources, historical data related to given resources, etc.

As used herein, resources can refer to and/or encompass a variety of different items such as, for example, financial resources (e.g., payments) and/or information technology resources (e.g., compute resources, storage resources, network resources, etc.).

The resource-related database 106 in the present embodiment is implemented using one or more storage systems associated with automated resource forecasting system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with automated resource forecasting system 105 are one or more input-output devices, which illustratively comprise keyboards, displays or other types of input-output devices in any combination. Such input-output devices can be used, for example, to support one or more user interfaces to automated resource forecasting system 105, as well as to support communication between automated resource forecasting system 105 and other related systems and devices not explicitly shown.

Additionally, automated resource forecasting system 105 in the FIG. 1 embodiment is assumed to be implemented using at least one processing device. Each such processing device generally comprises at least one processor and an associated memory, and implements one or more functional modules for controlling certain features of automated resource forecasting system 105.

More particularly, automated resource forecasting system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows automated resource forecasting system 105 to communicate over the network 104 with the user devices 102, and illustratively comprises one or more conventional transceivers.

The automated resource forecasting system 105 further comprises artificial intelligence-based partial information forecasting techniques 110, multi-temporal parameter-based regressor(s) 112, artificial intelligence-based resource-related prediction techniques 114, output consolidator 116, and automated action generator 118.

It is to be appreciated that this particular arrangement of elements 110, 112, 114, 116 and 118 illustrated in the automated resource forecasting system 105 of the FIG. 1 embodiment is presented by way of example only, and alternative arrangements can be used in other embodiments. For example, the functionality associated with elements 110, 112, 114, 116 and 118 in other embodiments can be combined into a single module, or separated across a larger number of modules. As another example, multiple distinct processors can be used to implement different ones of elements 110, 112, 114, 116 and 118 or portions thereof.

At least portions of elements 110, 112, 114, 116 and 118 may be implemented at least in part in the form of software that is stored in memory and executed by a processor.

It is to be understood that the particular set of elements shown in FIG. 1 for resource forecasting using artificial intelligence techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, automated resource forecasting system 105 and resource-related database 106 can be on and/or part of the same processing platform.

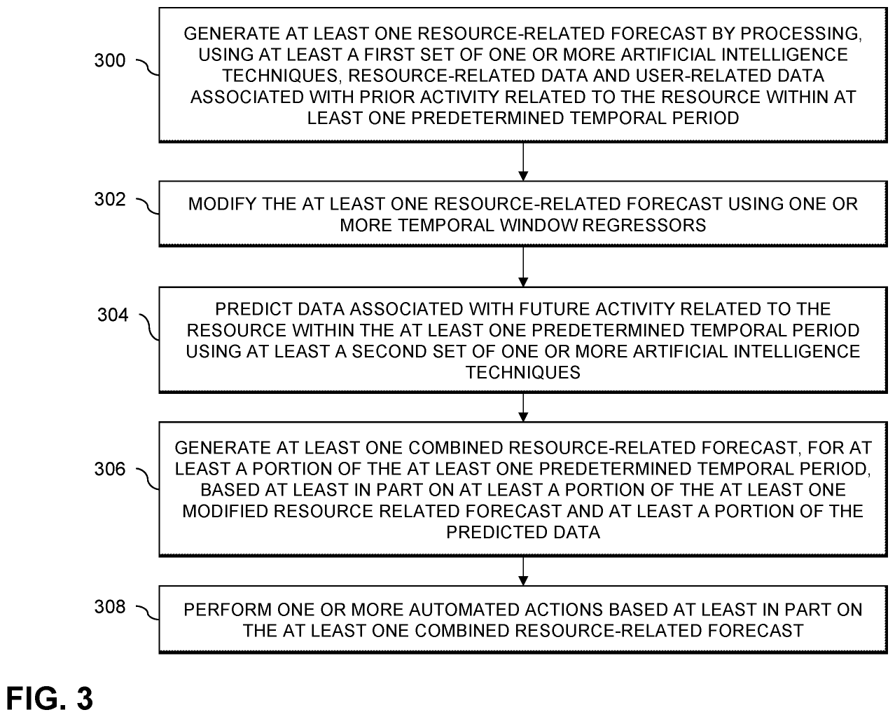

An exemplary process utilizing elements 110, 112, 114, 116 and 118 of an example automated resource forecasting system 105 in computer network 100 will be described in more detail with reference to the flow diagram of FIG. 3.

Accordingly, at least one embodiment includes resource forecasting using artificial intelligence techniques. By way merely of example and/or illustration, one or more embodiments can be implemented in connection with resource collection (e.g., payment and/or other monetary resource collection) activities across one or more temporal parameters (e.g., at least one rolling window such as a rolling weekly basis, a rolling quarterly basis, etc.). As further detailed herein, such an embodiment can include using one or more machine learning techniques to determine and/or decipher one or more non-linear trends across given sets of resource-related data.

Also, one or more embodiments can include implementing at least one rolling temporal window-based regressor that captures multiple temporal horizons such that at least one is tailored for at least one short-term resource-related forecast and at least one is tailored for at least one long-term resource-related forecast. Such forecasts can assist a given enterprise, for example, with respect to resource visibility, determining and/or understanding one or more drivers behind the forecast(s), proactively communicating with resource-related users, etc.

In accordance with at least one embodiment, artificial intelligence-based resource forecasting can include processing a variety of input data. For example, with respect to a cash forecast use case, such an embodiment can include, e.g., forecasting order revenue data by processing input data such as invoice-level data, historical bank statements, etc., and converting at least a portion of the input data using one or more lags related to order payment and forecasting at least a portion of the related cash flow.

As used herein, lagging a time series refers to shifting one or more values thereof forward one or more time steps, or to shifting the times in the corresponding index backward one or more steps. In either case, an effect is that the observations in the lagged series will appear to have happened later in time. By way merely of example, revenue received from orders can lag and such data can be modeled using linear regression techniques to improve the correlation of the raw data with target (e.g., revenue) data in accordance with one or more embodiments. For instance, if an enterprise receives an order of $800 for Week 1, the enterprise might receive $400 in Week 1, $300 in Week 2, and $100 in a subsequent week as deferred payments.

As further detailed herein, one or more embodiments include implementing a resource forecasting framework which accurately predicts one or more resource-related variables (e.g., cash collections) in accordance with one or more temporal bases (e.g., on a weekly level, on a quarterly level, etc.). Such an embodiment also includes providing flexibility to make one or more changes to a resource forecast, as well as enabling saving a forecast (e.g., as a draft) for future use and/or processing, and displaying any such forecasting changes via one or more user interfaces.

By way merely of example and illustration, consider a use case involving cash forecasting. In such a use case, closed invoices show what amount of cash was received from invoice-level data. Additionally, in accordance with an example embodiment, incorporating and/or processing open invoice data can facilitate understanding of open invoices and predicted payment amounts. Further, such an embodiment can include generating one or more grand total graphs, which depict relevant historical data and forecast data. In the case of the example use case noted above, the forecast data in such a graph can depict the amount(s) of cash expected in the future (e.g., from payment(s) of open invoices). Also, in such an example embodiment, an order data predicator can provide supplementary data such as, for example, order-related data derived from different and/or geographically disparate reporting teams, wherein such supplementary data are used to build and/or train the forecasting model(s).

Accordingly, and as further detailed herein, one or more embodiments include improving and/or enhancing resource forecasting by using and/or processing data such as, for example, historical user behavior data, resource collection performance-related data (e.g., data pertaining to general resource-related trends, data pertaining to specific users and/or user-related trends), as well as reducing (e.g., minimizing) the number of manual adjustments and/or assumptions required.

Referring again to the above-noted example cash forecasting use case, one or more embodiments can include integrating partial information available from data pertaining to open invoices. Also, considering that invoice-level data can be used to analyze the number of closed invoices, processing such data in addition to the data from pertaining to open invoices can result in predicting when one or more of the open invoices will close. Based at least upon such predictions, one or more embodiments can also include predicting an aggregated cash receiving date related to one or more of the open invoices (e.g., on a basis of weekly invoice closing(s)).

In at least one example embodiment, integrating partial information from invoices indicates that at any point in time, when a prediction is made, visibility may only apply to or be available for a portion of invoices for the given quarter. For example, at the start of a first quarter, assume that historically the given enterprise has received approximately $800 from invoices, but the open invoices at that time state only $150, which means that the rest will flow over a subsequent period of time. This $150 can either be integrated or discarded, and it provides an understanding of a trend change which might have happened due, e.g., to market fluctuations. If the enterprise was supposed to receive $150 at the start of the quarter, then that is in line with the expected payments; otherwise, if the enterprise received $100, the model could make one or more conservative predictions, or if the enterprise received $200, the model could adjust and increase the expected forecast for the quarter. Such an example embodiment can include using at least one regression model (e.g., at least one decision tree gradient boosting algorithm such as, for example, CatBoost) to forecast the dates of open invoices learning from the user/customer behavior related to closed invoices.

As noted herein, one or more embodiments can include using and/or processing data pertaining to user behavior as part of related resource forecasting. By way merely of illustration, using the above-noted example cash forecasting use case, behavior of a particular user can act as an indicator. For example, behavior data may indicate that a first user typically pays an invoice in x number of days while a second user typically pays an invoice in y number of days. In addition to consideration of user-specific payment due dates, such behavior data can be leveraged to improve and/or fine-tune related cash forecasting (e.g., predicting how much cash is expected to arrive in a given week and/or a given quarter).

Additionally, in at least one embodiment, enterprise data (e.g., business segment dependency information related to the resource(s) in question) can be leveraged and/or processed in connection with resource forecasting. For example, actions and/or behavior of different groups and/or segments within the given enterprise can vary, and as such, integrating data related thereto can enhance and/or improve the corresponding resource forecasting.

Accordingly, at least one embodiment includes generating and/or implementing at least one artificial intelligence-based strategy that includes training at least one artificial intelligence model using historical data in addition to and/or in conjunction with data and/or insights related to resource-level data (e.g., invoice-level data) user behavior data, and enterprise data (e.g., business segment dependency information).

Referring again to the example cash forecasting use case, because open invoices can vary with respect to visibility (e.g., open invoices may only be visible for a given week, some invoices might close while some invoices might be opened in the same week, etc.), one or more embodiments include generating at least one estimate for upcoming invoices based at least in part on historical invoice-related data and current data pertaining to invoices which are still open. By way of example, such an embodiment can include using one or more short-term and/or long-term rolling windows to simulate what payments would be collected if there was no exposure to 4/N weeks of invoices. Such an embodiment includes generating and/or providing rolling window-based supporting data, which can be used in conjunction with actual payment data (e.g., accounts receivable data) to provide a more robust cash forecast. For example, such an embodiment can include processing such forms of data using one or more time series forecasting models (e.g., Prophet), creating both short-term visibility and long-term visibility for the resource.

By way of example, such an embodiment can include using two different periods to make a forecast more robust. For instance, one period can include a short-term period forecasting four weeks out, for which the partial information from invoices is engineered to simulate four weeks of behavior into the history. Additionally, in such an embodiment, partial information from falling off predictions, determined based at least in part on a lack of visibility of future invoices, can also be simulated into the history. Also, and in connection with the above-noted example related to simulating what payments would be collected if there was no exposure to 4/N weeks of invoices, the term “N” is dynamic. If the current time is week 10 of a given quarter, then at least one forecast is generated for the remaining four weeks of that quarter and also for the upcoming quarter as a long-term forecast (e.g., N=4+13 in that case). More generally, the use of “N” facilitates a long-term robust forecast apart from a short-term window (e.g., of just four weeks in the above example).

As also detailed above and herein, as behavior across different groups and/or segments within an enterprise (e.g., an enterprise related to a resource being forecasted) can vary, one or more embodiments include implementing different models to capture data pertaining to such varying behavior. For example, using Pareto analysis, a given use case can include a scenario wherein approximately 20% of the invoices contribute to approximately 80% of the revenue. Further analysis can then be carried out, for example, to separately accommodate and/or process large invoices and small invoices. In such an example use case, it can be determined that the smaller invoices do not significantly affect the grand total, a determination which can help in reducing noise in the ultimate forecasting model and/or making the ultimate forecasting model more robust. Such determinations can also help understand behavior (e.g., payment behavior) at different segment levels of an enterprise as well as within one or more segments.

As also noted above and further detailed herein, one or more embodiments include implementing at least one rolling window approach for resource-related data (e.g., invoice-level data in the context of cash forecasting). Referring again, for example, to the example cash forecasting use case, at least one embodiment can include predicting the closing date of an invoice based at least in part on relevant historical user behavior (e.g., historical user payment data, historical user payment-related temporal data, etc.). Such an embodiment can include identifying resource-related trends with one or more users and/or initiating one or more automated actions in response to the identification of such trends (e.g., generating user communications, etc.).

Also, one or more embodiments can include leveraging dispute-level information to understand if a given resource is involved in a dispute, potentially affecting one or more resource-related timelines (e.g., an invoice being currently involved in a dispute can delay closing).

As such, at least one embodiment includes using at least one rolling temporal window to capture corresponding data and aggregate at least a portion of such data to determine and/or generate an understanding of resource-related information (e.g., invoices that are likely to close during a given timeframe and the associated revenue to be received). Such a rolling window approach can ensure that there are multiple temporal aspects (e.g., short-term and long-term) to resource forecasting, wherein such temporal aspects can be set and/or selected dynamically.

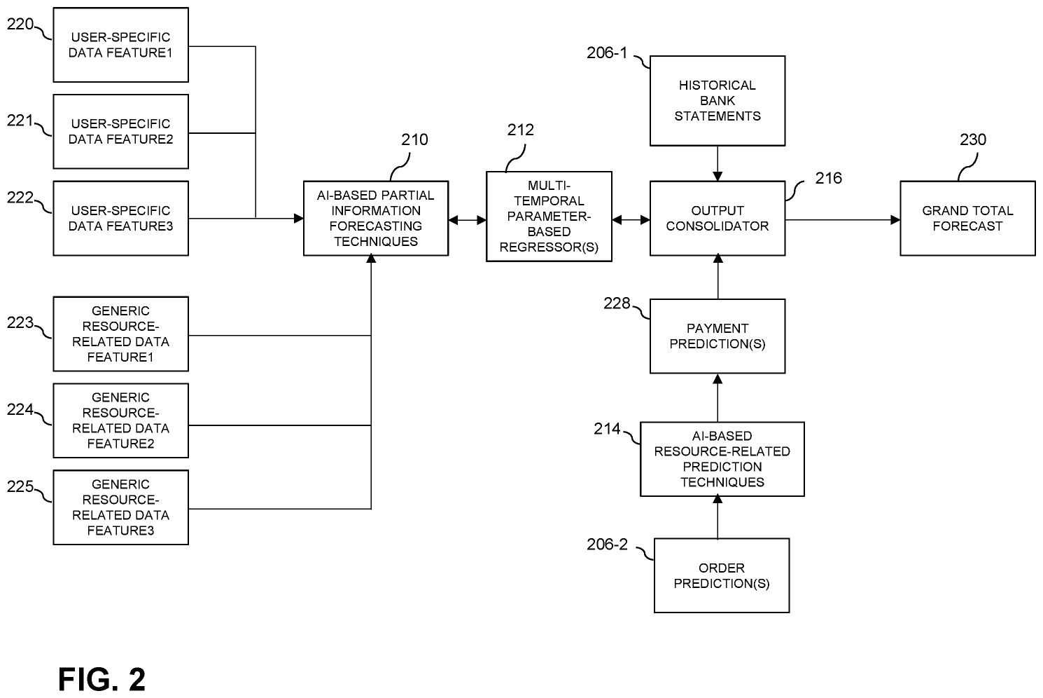

As further detailed in connection with FIG. 2, based at least in part on the rolling window approach, at least one embodiment includes building and/or implementing two or more forecasting models, merging at least a portion of the results of the two or more forecasts (e.g., implementing a short-term forecasting model that is based on four week periods, and appending thereto a long-term forecasting model such that two forecast overviews are provided and/or utilized), and consolidating at least a portion of the data related thereto to provide a final resource forecast.

By way merely of example, assume that a selected temporal period is ten weeks. In such an example scenario, at least one embodiment can include considering and/or processing only those invoices which were open ten weeks ago and have closed and/or are predicted to close for the particular week under consideration, and such a process is carried out for all relevant weeks on a rolling basis. Further, in such an example embodiment, the sum of all of the invoice payments from the closed invoices represents the grand total, and the artificial intelligence-based model which incorporates data pertaining to the invoices predicted to close can be implemented to update and/or modify the grand total. Accordingly, as detailed herein, the artificial intelligence-based model facilitates the generation of a more accurate prediction (e.g., more accurate than the grand total) by leveraging at least one regressor.

For multi-variant time series forecasting, one or more external factors can be utilized and/or leveraged which can impact the final resource-related forecast. As such, at least one embodiment includes incorporating at least one regressor. In such an embodiment, a rolling window regressor can include multiple types of defined periods, such as, for example, a short-term forecast period and a long-term forecast period. Additionally, in such an embodiment, multi-variant time series forecasting can include using one or more multivariate time series models (e.g., NeuralProphet, DeepVAR, etc.) and/or one or more regression models (e.g., XGBoost) in connection with at least one target variable (e.g., revenue) and one or more temporal periods and/or values.

By way merely of example and illustration, consider a short-term forecast period having a four week window. Accordingly, for every week to be processed, an example embodiment includes summing all of the invoices for four weeks only. More specifically, for every week to be processed, all open invoices (and/or payments thereof) which were opened four weeks prior to the current time slot are summed, and this process is iterated over every week to be processed with a window of four weeks. For example, if the current week is Week 50 and the rolling temporal period is four weeks, any invoices opened prior to Week 46 are ignored. Further, when in Week 49, any invoice opened prior to Week 45 is ignored, etc.

By way of further example, with respect to a long-term forecast period, at least one embodiment includes dynamically selecting and/or determining such a period. For example, consider a use case wherein a cash forecast is to be provided for two given annual quarters (i.e., 26 weeks). When the current week is Week 5, four weeks are over, and eight weeks remain for the given quarter and thirteen weeks remain until the end of the second of the two quarters. Accordingly, in such an example, the long-term forecast period should be dynamically set to 21 weeks. As such, for example, in Week 51, the artificial intelligence-based forecasting model will not process and/or take into consideration any invoices from prior to Week 30. In accordance with this long-term forecast period, the artificial intelligence-based forecasting model will sum the invoices (and/or payments thereof) in a rolling window fashion, such as detailed above and herein.

As noted above, one or more embodiments include building and/or implementing two or more models (based, for example, on a short-term forecast period and a long-term forecast period), and merging at least a portion of the results of both models. Accordingly, such an embodiment includes creating two different historical simulations to conform to a given situation that includes lack of visibility for a short-term time horizon and a longer-term time horizon, which can result in an improvement over a single long-term forecast which can deteriorate in accuracy over time.

Such an artificial intelligence-based forecasting model can be further tuned based at least in part on behavior data such as, for example, trend data, seasonality data, etc. In at least one embodiment, a testing period for such a model can be defined to be a period suited for at least one short-term and long-term regressor, as the data being rolled up given the period is different, and the impact on the short-term and long-term forecasts differs as well. Additionally, in such an embodiment, tuning one or more model parameters catering to new data before concatenating can provide a more robust forecast.

In one or more embodiments, model parameters can be selected and/or learned based at least in part on the chosen loss function and the validation dataset. For example, if an embodiment includes creating a robust forecast for a period of four weeks, the period of testing should be based on (e.g., the same as) what the model is tuned for, with n iterations to choose the model parameters to reduce one or more key performance indicators (KPIs) (e.g., lower mean absolute percentage error, reduced fluctuations per weekly forecast, etc.). The testing period can be derived, for example, from an understanding of when enterprise decisions are made, and can be adjusted to suit one or more related needs accordingly.

Additionally, and by way merely of example, time series data can be expressed as a combination of Fourier series, and as such, one or more embodiments can include dividing and/or partitioning the data into groups and/or categories related to trends, seasonality, at least one random error term, etc. Also, the model parameters include at least one value of a Fourier series that is apt, and/or what level of flexibility should be added to the model to adjust to future data.

As detailed herein, user-level data and generic resource-related data can be aggregated in connection with one or more resource forecasts, and as such, one or more embodiments can include utilizing both types of data in connection with mapping individual user workflows and/or resource-related journeys. For a new user, with no existing data, such an embodiment can include selecting and/or utilizing data based at least in part on one or more historically relevant parameters (e.g., behavior of similar users, etc.).

FIG. 2 shows example system architecture in an illustrative embodiment. By way of illustration, FIG. 2 depicts user-specific data features 220, 221 and 222 (e.g., user invoice information, expected closed invoice gap(s), late payment gap(s) average, etc.), as well as generic resource-related data features 223, 224 and 225 (e.g., invoice amounts, due invoice gap(s), go to market information, etc.). At least a portion of such data features are fed to and/or processed by artificial intelligence-based partial information forecasting techniques 210, wherein one or more hyperparameter choices can be made to determine one or more parameters leading to an increasing confidence level associated with the artificial intelligence-based partial information forecasting techniques 210. In accordance with the example embodiment depicted in FIG. 2 and directed to a cash forecast use case, artificial intelligence-based partial information forecasting techniques 210 can determine and/or predict one or more details, e.g., pertaining to when one or more open invoice will close.

Outputs generated by artificial intelligence-based partial information forecasting techniques 210 (e.g., open invoice(s) to closed invoice(s) temporal information, etc.) are then provided to and/or processed by multi-temporal parameter-based regressor(s) 212, which can implement a rolling window approach incorporating multiple regressors (e.g., a long-term regressor and a short-term regressor).

In one or more embodiments, such a rolling window approach can include simulating revenue to be collected in the absence of upcoming invoices, projecting such revenue based at least in part on historical data. Such projected data can then be used, for example, to support the given resource forecast (e.g., with respect to a cash forecast associated with invoices in upcoming weeks). As detailed herein, such an embodiment can include branching a model (e.g., in connection with multi-temporal parameter-based regressor(s) 212) into short-term and long-term windows, and integrating such resulting data for robust predictions with a focus on their determined temporal periods.

As also depicted in FIG. 2, output(s) generated in connection with multi-temporal parameter-based regressor(s) 212 are provided to and/or processed by output consolidator 216 in addition to resource-related data such as historical bank statements 206-1. Further, artificial intelligence-based resource-related prediction techniques 214 process resource-related information such as information associated with order prediction(s) 206-2 (e.g., including data which contain historical records of orders made and revenue generated per enterprise segment, and also including one or more future forecasts), and generates one or more payment predictions 228 for possible future resource-related orders (e.g., within a given temporal period). At least a portion of the payment predictions 228 are provided to output consolidator 216, which, in conjunction with the other above-noted data and/or outputs, determines a grand total forecast 230.

In one or more embodiments, such a final forecast (i.e., grand total forecast 230) can be leveraged and/or processed by an automated action generator (such as, e.g., element 118 in the FIG. 1 embodiment) to initiate one or more automated actions. For example, one or more communications can be initiated with one or more users (e.g., potential defaulters) regarding a given payment, at least one of the artificial intelligence-based techniques can be tuned and/or trained based at least in part on the final forecast, etc. By way of further example, initiating one or more automated actions can include automatically allocating resources in at least one information technology infrastructure and/or migrating one or more portions of at least one information technology workflow from one set of resources to another set of resources.

It is to be appreciated that some embodiments described herein utilize one or more artificial intelligence models. It is to be appreciated that the term “model,” as used herein, is intended to be broadly construed and may comprise, for example, a set of executable instructions for generating computer-implemented predictions. For example, one or more of the models described herein may be trained to generate predictions based on historical data, user data, enterprise data, behavior data, etc., and such predictions can be used to initiate one or more automated actions (e.g., automatically generating and/or outputting communications to one or more users, automatically training one or more artificial intelligence techniques, etc.).

FIG. 3 is a flow diagram of a process for resource forecasting using artificial intelligence techniques in an illustrative embodiment. It is to be understood that this particular process is only an example, and additional or alternative processes can be carried out in other embodiments.

In this embodiment, the process includes steps 300 through 308. These steps are assumed to be performed by automated resource forecasting system 105 utilizing elements 110, 112, 114, 116 and 118.

Step 300 includes generating at least one resource-related forecast by processing, using at least a first set of one or more artificial intelligence techniques, resource-related data and user-related data associated with prior activity related to the resource within at least one predetermined temporal period. In at least one embodiment, processing, using at least a first set of one or more artificial intelligence techniques, resource-related data and user-related data includes processing, using one or more multi-variant time series forecasting models the resource-related data and the user-related data. Additionally or alternatively, processing user-related data associated with prior activity related to the resource can include processing data pertaining to one or more user behavior trends in connection with the resource and/or processing enterprise-related dependency information associated with the resource. Further, in at least one embodiment, processing resource-related data can include processing dispute-related information associated with the resource to determine one or more temporal effects on the at least one resource-related forecast.

Step 302 includes modifying the at least one resource-related forecast using one or more temporal window regressors. In one or more embodiments, modifying the at least one resource-related forecast using one or more temporal window regressors includes using multiple rolling temporal window regressors, wherein a first temporal window regressor includes a first predetermined amount of time and wherein at least a second temporal window regressor includes at least a second predetermined amount of time longer than the first predetermined amount of time.

Step 304 includes predicting data associated with future activity related to the resource within the at least one predetermined temporal period using at least a second set of one or more artificial intelligence techniques. Step 306 includes generating at least one combined resource-related forecast, for at least a portion of the at least one predetermined temporal period, based at least in part on at least a portion of the at least one modified resource related forecast and at least a portion of the predicted data.

Step 308 includes performing one or more automated actions based at least in part on the at least one combined resource-related forecast. In at least one embodiment, performing one or more automated actions includes automatically generating at least one communication to at least one user based at least in part on the at least one combined resource-related forecast. Additionally or alternatively, performing one or more automated actions can include automatically training at least a portion of the first set of one or more artificial intelligence techniques using feedback related to the at least one combined resource-related forecast and/or automatically training at least a portion of the second set of one or more artificial intelligence techniques using feedback related to the at least one combined resource-related forecast.

Accordingly, the particular processing operations and other functionality described in conjunction with the flow diagram of FIG. 3 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically forecast resources using artificial intelligence techniques. These and other embodiments can effectively overcome problems associated with inaccuracies and/or errors.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

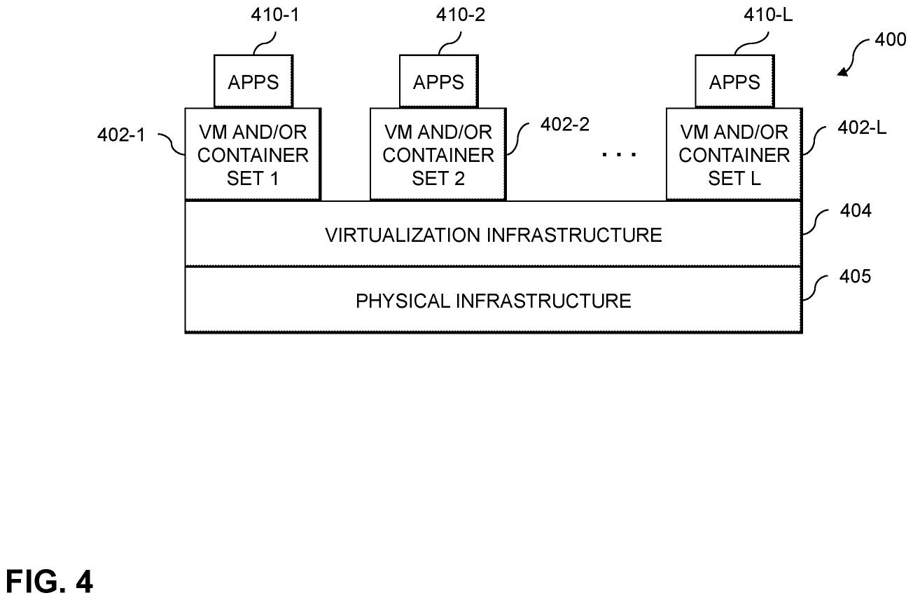

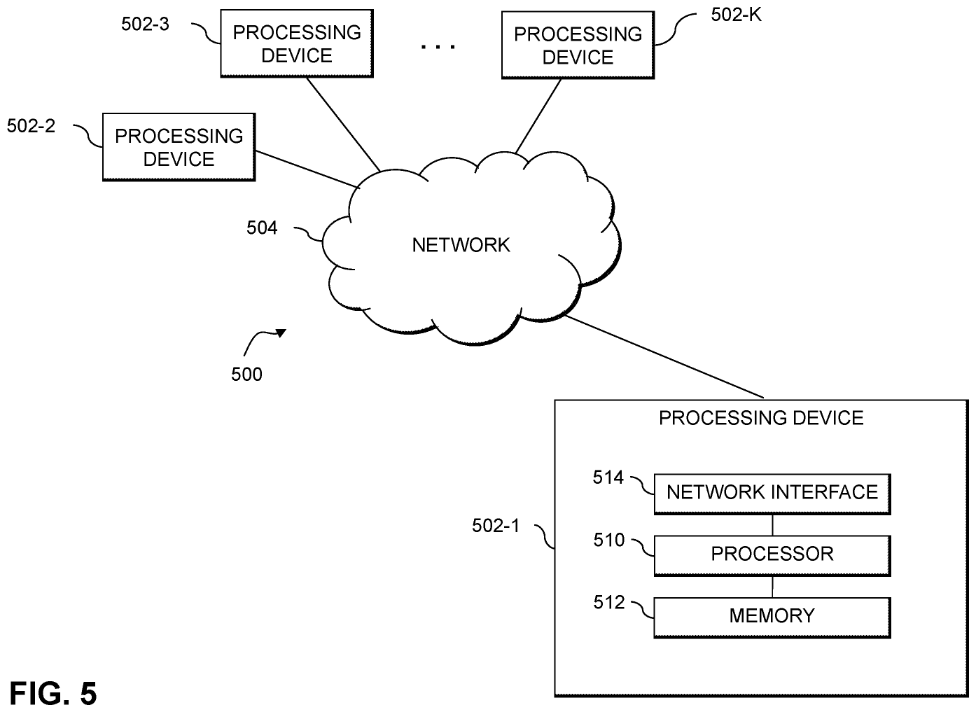

Illustrative embodiments of processing platforms will now be described in greater detail with reference to FIGS. 4 and 5. Although described in the context of system 100, these platforms may also be used to implement at least portions of other information processing systems in other embodiments.

FIG. 4 shows an example processing platform comprising cloud infrastructure 400. The cloud infrastructure 400 comprises a combination of physical and virtual processing resources that are utilized to implement at least a portion of the information processing system 100. The cloud infrastructure 400 comprises multiple virtual machines (VMs) and/or container sets 402-1, 402-2, . . . 402-L implemented using virtualization infrastructure 404. The virtualization infrastructure 404 runs on physical infrastructure 405, and illustratively comprises one or more hypervisors and/or operating system level virtualization infrastructure. The operating system level virtualization infrastructure illustratively comprises kernel control groups of a Linux operating system or other type of operating system.

The cloud infrastructure 400 further comprises sets of applications 410-1, 410-2, . . . 410-L running on respective ones of the VMs/container sets 402-1, 402-2, . . . 402-L under the control of the virtualization infrastructure 404. The VMs/container sets 402 comprise respective VMs, respective sets of one or more containers, or respective sets of one or more containers running in VMs. In some implementations of the FIG. 4 embodiment, the VMs/container sets 402 comprise respective VMs implemented using virtualization infrastructure 404 that comprises at least one hypervisor.

A hypervisor platform may be used to implement a hypervisor within the virtualization infrastructure 404, wherein the hypervisor platform has an associated virtual infrastructure management system. The underlying physical machines comprise one or more information processing platforms that include one or more storage systems.

In other implementations of the FIG. 4 embodiment, the VMs/container sets 402 comprise respective containers implemented using virtualization infrastructure 404 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 400 shown in FIG. 4 may represent at least a portion of one processing platform. Another example of such a processing platform is processing platform 500 shown in FIG. 5.

The processing platform 500 in this embodiment comprises a portion of system 100 and includes a plurality of processing devices, denoted 502-1, 502-2, 502-3, . . . 502-K, which communicate with one another over a network 504.

The network 504 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 502-1 in the processing platform 500 comprises a processor 510 coupled to a memory 512.

The processor 510 comprises a microprocessor, a CPU, a GPU, a TPU, a microcontroller, an ASIC, a FPGA or other type of processing circuitry, as well as portions or combinations of such circuitry elements.

The memory 512 comprises random access memory (RAM), read-only memory (ROM) or other types of memory, in any combination. The memory 512 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 502-1 is network interface circuitry 514, which is used to interface the processing device with the network 504 and other system components, and may comprise conventional transceivers.

The other processing devices 502 of the processing platform 500 are assumed to be configured in a manner similar to that shown for processing device 502-1 in the figure.

Again, the particular processing platform 500 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
generating at least one resource-related forecast by processing, using at least a first set of one or more artificial intelligence techniques, resource-related data and user-related data associated with prior activity related to the resource within at least one predetermined temporal period;
modifying the at least one resource-related forecast using one or more temporal window regressors;
predicting data associated with future activity related to the resource within the at least one predetermined temporal period using at least a second set of one or more artificial intelligence techniques;
generating at least one combined resource-related forecast, for at least a portion of the at least one predetermined temporal period, based at least in part on at least a portion of the at least one modified resource related forecast and at least a portion of the predicted data; and
performing one or more automated actions based at least in part on the at least one combined resource-related forecast;
wherein the method is performed by at least one processing device comprising a processor coupled to a memory.

2. The computer-implemented method of claim 1, wherein modifying the at least one resource-related forecast using one or more temporal window regressors comprises using multiple rolling temporal window regressors, wherein a first temporal window regressor comprises a first predetermined amount of time and wherein at least a second temporal window regressor comprises at least a second predetermined amount of time longer than the first predetermined amount of time.

3. The computer-implemented method of claim 1, wherein processing, using at least a first set of one or more artificial intelligence techniques, resource-related data and user-related data comprises processing, using one or more multi-variant time series forecasting models the resource-related data and the user-related data.

4. The computer-implemented method of claim 1, wherein processing user-related data associated with prior activity related to the resource comprises processing data pertaining to one or more user behavior trends in connection with the resource.

5. The computer-implemented method of claim 1, wherein processing resource-related data comprises processing enterprise-related dependency information associated with the resource.

6. The computer-implemented method of claim 1, wherein performing one or more automated actions comprises automatically generating at least one communication to at least one user based at least in part on the at least one combined resource-related forecast.

7. The computer-implemented method of claim 1, wherein performing one or more automated actions comprises automatically training at least a portion of the first set of one or more artificial intelligence techniques using feedback related to the at least one combined resource-related forecast.

8. The computer-implemented method of claim 1, wherein performing one or more automated actions comprises automatically training at least a portion of the second set of one or more artificial intelligence techniques using feedback related to the at least one combined resource-related forecast.

9. The computer-implemented method of claim 1, wherein processing resource-related data comprises processing dispute-related information associated with the resource to determine one or more temporal effects on the at least one resource-related forecast.

10. A non-transitory processor-readable storage medium having stored therein program code of one or more software programs, wherein the program code when executed by at least one processing device causes the at least one processing device:
to generate at least one resource-related forecast by processing, using at least a first set of one or more artificial intelligence techniques, resource-related data and user-related data associated with prior activity related to the resource within at least one predetermined temporal period;
to modify the at least one resource-related forecast using one or more temporal window regressors;
to predict data associated with future activity related to the resource within the at least one predetermined temporal period using at least a second set of one or more artificial intelligence techniques;
to generate at least one combined resource-related forecast, for at least a portion of the at least one predetermined temporal period, based at least in part on at least a portion of the at least one modified resource related forecast and at least a portion of the predicted data; and
to perform one or more automated actions based at least in part on the at least one combined resource-related forecast.

11. The non-transitory processor-readable storage medium of claim 10, wherein modifying the at least one resource-related forecast using one or more temporal window regressors comprises using multiple rolling temporal window regressors, wherein a first temporal window regressor comprises a first predetermined amount of time and wherein at least a second temporal window regressor comprises at least a second predetermined amount of time longer than the first predetermined amount of time.

12. The non-transitory processor-readable storage medium of claim 10, wherein processing, using at least a first set of one or more artificial intelligence techniques, resource-related data and user-related data comprises processing, using one or more multi-variant time series forecasting models the resource-related data and the user-related data.

13. The non-transitory processor-readable storage medium of claim 10, wherein processing user-related data associated with prior activity related to the resource comprises processing data pertaining to one or more user behavior trends in connection with the resource.

14. The non-transitory processor-readable storage medium of claim 10, wherein processing resource-related data comprises processing enterprise-related dependency information associated with the resource.

15. The non-transitory processor-readable storage medium of claim 10, wherein performing one or more automated actions comprises automatically generating at least one communication to at least one user based at least in part on the at least one combined resource-related forecast.

16. An apparatus comprising:
at least one processing device comprising a processor coupled to a memory;
the at least one processing device being configured:
to generate at least one resource-related forecast by processing, using at least a first set of one or more artificial intelligence techniques, resource-related data and user-related data associated with prior activity related to the resource within at least one predetermined temporal period;
to modify the at least one resource-related forecast using one or more temporal window regressors;
to predict data associated with future activity related to the resource within the at least one predetermined temporal period using at least a second set of one or more artificial intelligence techniques;
to generate at least one combined resource-related forecast, for at least a portion of the at least one predetermined temporal period, based at least in part on at least a portion of the at least one modified resource related forecast and at least a portion of the predicted data; and
to perform one or more automated actions based at least in part on the at least one combined resource-related forecast.

17. The apparatus of claim 16, wherein modifying the at least one resource-related forecast using one or more temporal window regressors comprises using multiple rolling temporal window regressors, wherein a first temporal window regressor comprises a first predetermined amount of time and wherein at least a second temporal window regressor comprises at least a second predetermined amount of time longer than the first predetermined amount of time.

18. The apparatus of claim 16, wherein processing, using at least a first set of one or more artificial intelligence techniques, resource-related data and user-related data comprises processing, using one or more multi-variant time series forecasting models the resource-related data and the user-related data.

19. The apparatus of claim 16, wherein processing user-related data associated with prior activity related to the resource comprises processing data pertaining to one or more user behavior trends in connection with the resource.

20. The apparatus of claim 16, wherein performing one or more automated actions comprises automatically generating at least one communication to at least one user based at least in part on the at least one combined resource-related forecast.
